(19) United States
(12) Patent Application Publication
(10) Pub. No.: US 2020/0282580 A1
(43) Pub. Date: Sep. 10, 2020

(54) Electric razor for shaving contoured body surfaces

(71) Applicant: Landon D. McKinnis, Kenosha, WI (US)

(72) Inventor: Landon D. McKinnis, Kenosha, WI (US)

(21) Appl. No.: 16/785,539

(22) Filed: Feb. 7, 2020

Related U.S. Application Data
(60) Provisional application No. 62/802,712, filed on Feb. 7, 2019.

(51) Int. Cl. B26B 19/38; B26B 19/14

(52) U.S. Cl. CPC B26B 19/384; B26B 19/143; B26B 19/3853; B26B 19/3873; B26B 19/141

(57) ABSTRACT

An electric razor for ergonomically and safely shaving contoured areas of the body, such as the armpit, pubic, and groin areas, without undue hand or wrist contortion. The razor features a cutting head of blades that are arranged to compositely form a spherical cap-shaped cutting surface.

This non-provisional application claims the benefit of provisional application No. 62/802,712 filed Feb. 7, 2019.

### BACKGROUND

The present invention generally relates electric razors, and it is specifically directed to an electric razor that has a cutting profile which is ergonomically shaped to comfortably shave contoured and pocketed areas of the body, such as armpits, pubic, and groin areas.

For thousands of years, men have been using razors to shave unwanted hair from their bodies. Initially (and still today), open razors were used and, then, safety razors were developed to prevent cutting injuries. Both categories of razors feature a straight blade which must be skillfully slid over and against any contoured area of the body—more skillfully in the case of an open razor—in order to cut off hair without lacerating the skin. Nevertheless, many men (and women) have accidentally cut themselves, or at least caused skin irritation, as a result of using these straight blade-type razors. And because the prospect of accidentally cutting or irritating skin around the scrotum or penis is especially untenable, most men do not dare consider even the safety type of straight razor as a viable tool for shaving their pubic areas. Instead, for those areas, the more modern electric razor is the only viable choice.

Electric razors (also referred to as “electric shavers”) fall into two basic categories: rotary type and foil type. Typically, the rotary-type electric razor is defined by having a cutting head surface upon which multiple rotary blade assemblies—usually three of them arranged in triangular relation—are mounted. Each rotary blade assembly features an outer cutter which remains fixed relative to an inner cutter that is spun by an electric-powered motor and drive assembly. The outer cutter has grooves formed within it that allow hair to enter and to be cut by and between the rotationally fixed outer cutter and the rotating inner cutter. In some rotary electric razors of the prior art, the cutting head surface is a platform that is pivotally mounted to the handle portion of the device so that the rotary blade assemblies can be pivoted in a rounded cutting motion to at least somewhat follow the counters of the face, scalp and body. This relieves the user's wrist of being the only thing that imparts pivotal movement of the cutting head.

Nevertheless, because the rotary blade assemblies are mounted substantially in plane with each other, they form a cutting surface that is substantially flat and unable to completely meet the contours of some junctional and pocketed areas of the body, such as those around the groin. Also, the same blade assembly configuration that inhibits the skin from lodging deep enough into the openings formed within the outer cutters to ever be in serious jeopardy of being lacerated by the rotating inner cutters also tends to produce a less close shave than may be desired.

Foil-type razors, on the other hand, are usually capable of providing a closer shave. They are, typically, characterized by having a straight row of rounded profile blades oriented in parallel, which are covered by a very closely positioned and highly perforated, malleable sheet of thin metal called a “foil” or “screen”. An electric motor imparts oscillating movement to the blades which, in turn, cuts hairs that protrude through openings in the screen. Because the screen is arched to match the profile of the blades with very little separation distance, a close shave can be achieved. However, as it relates to shaving the male pubic areas, contemporary foil electric razors may also be deemed insufficient.

To wit, because the razor blades are usually arranged in a straight row(s) and oscillate back and forth in directions normal to the planes of the blades, the combination of screen and blades forms one or two straight (one for each blade row), albeit tightly rounded, cutting surfaces. Consequently, it takes considerable, and awkward, hand and wrist contortion and/or hand positioning along a contemporary foil electric razor to achieve an even shave of all the various delicately shaped surfaces of the male pubic and groin areas.

As such, there is an outstanding need for an electric razor device that is configured to achieve both the close shave of a traditional foil-type razor, but with a more broadly rounded cutting profile that enables it to be comfortably positioned flush against the skin of more concavely or convexly contoured areas of the body without undue user manipulation and, thusly, renders it effective for shaving the armpit, pubic, and groin areas. The present electric razor substantially fulfills this need.

### SUMMARY OF THE INVENTION

It is an object of the present invention to provide a shaving razor which has a cutting head with a semispherical cutting surface that makes it ergonomically suited to shave concavely and convexly contoured areas of the body, including the armpits and the male groin and pubic areas.

In one aspect, the invention may feature a foil or screen guard that closely shields rotating rings of foil blades which are in axial alignment along separate vertical planes such that the screen and closely underlying blades create a composite spherical cap-shaped cutting surface. In another aspect, the invention may be devoid of a screen, but feature a series of rotary blades that are in similar axial and vertical stepped alignment to render a similar shaped cutting surface. And in yet another aspect, the invention may feature multiple non-concentric rotary blades that are positioned non-planarly along a spherical cap-shaped face to, themselves, compositely form a cutting surface of similar profile.

### BRIEF DESCRIPTION OF THE DRAWINGS

FIG. 1 is a side elevational view of a foil cutter-type electric razor in accordance with the present invention;

FIG. 2 is the same, but with the screen shown detached from the rest of the device;

FIG. 3 is a bottom perspective view of an electric razor in accordance with the present invention;

FIG. 4 is a side elevational view of a concentric rotary blade-type electric razor in accordance with the present invention;

FIG. 5 is a top perspective view of a non-concentric rotary blade-type electric razor in accordance with the present invention; and

FIG. 6 is a cross-sectional, elevational view of the same.

### DETAILED DESCRIPTION OF THE PREFERRED EMBODIMENTS

This disclosure, as defined by the claims that follow, relates to an electric razor that has a composite spherical cap-shaped cutting surface that is so shaped to comfortably and safely shave contoured parts of the body, such as the male groin and pubic areas. As will be discussed, it is anticipated that, within the scope of the invention, the present razor may be either: (a) substantially spherical in its entirety; or (b) semispherical only in its cutting head portion (and more elongate or other shaped in its gripping portion). Within that scope, it is also anticipated that the present razor's cutting head may be formed by either: (c) multiple rotary blade assemblies that are concentrically arranged in vertical stepped relation so as to form a non-planar, composite spherical cap-shaped cutting surface; (d) multiple rotary blade assemblies that are non-concentric and, instead, are positioned in non-planar relation such that they form a composite spherical cap-shaped cutting surface; or (e) multiple foil-type blade assemblies that are rotated or oscillated, and that are concentrically arranged in vertical stepped relation closely underneath a spherical cap-shaped foil screen.

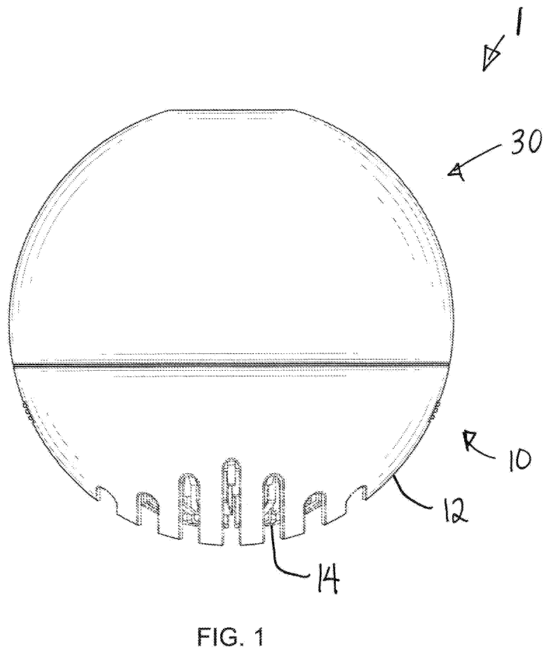

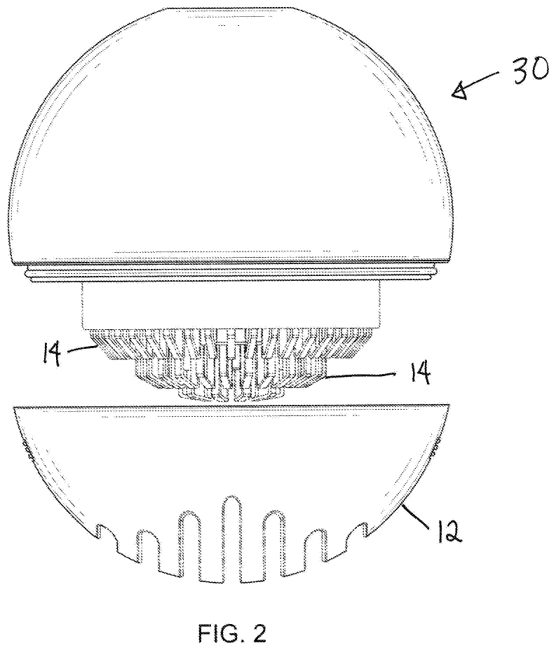

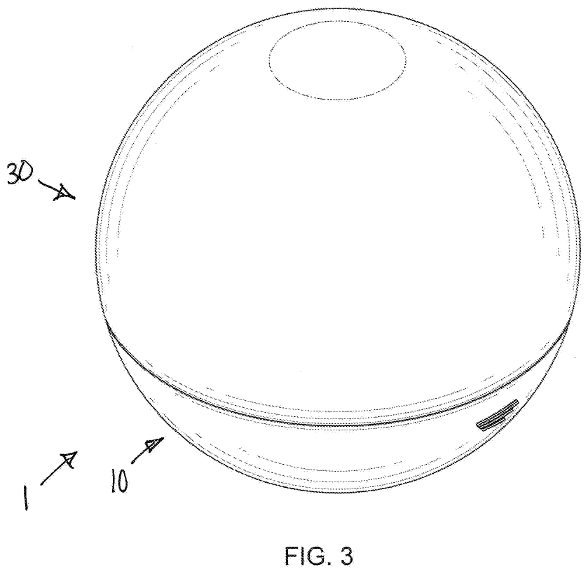

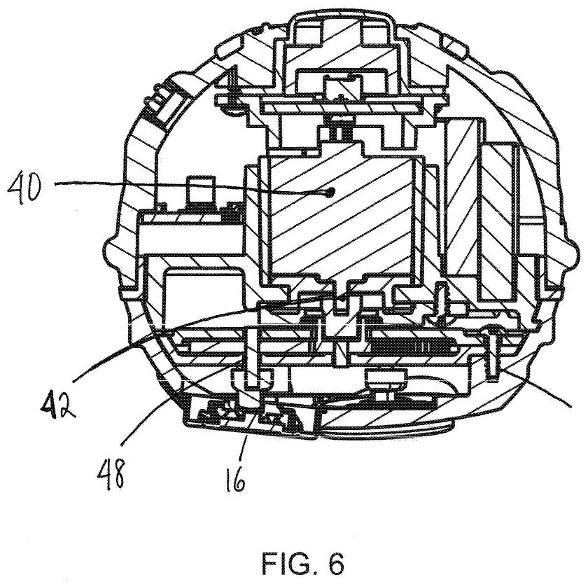

Accordingly, in a first preferred embodiment depicted in FIGS. 1-3, the present razor 1 is a foil-type electric razor formed of a cutting head portion 10 and a gripping portion 30. Although both such portions 10, 30 are shown as being semispherical and the overall device 1 sphere shaped, it is contemplated that the gripping portion 30 may take on any number of different profiles and may be more elongate and handle shaped. Regardless, the cutting head portion 10 primarily constitutes a perforated screen 12 and a series of foil-type blades 14. Internally positioned within the razor 1 is an electric motor 40 that is operatively connected to a drive mechanism (as can be gleaned from viewing FIG. 6) for imparting fully rotational or rotationally oscillatory movement to the blades 14.

In this first embodiment, the foil-type blades 14 are separate rings of blades in which the rings are axially aligned. An outermost ring of greatest diameter is at the relatively lowest, as between all blade rings 14, vertical position (when considering the cutting head portion 10 as the top and the gripping portion 30 as the bottom of the device 1). Each progressively smaller diametered blade ring 14 is mounted vertically higher than the next ring 14 such that they, altogether, form a spherical cap-shaped cutting profile that matches the profile of the screen 12 when they are fully rotating or rotationally oscillating.

The perforated screen 12 fits over the blades 14 with very little clearance between them. The screen 12 features several openings which can be circular, linear or otherwise. The screen 12 functions to protect a user from the, otherwise, exposed blade cutting surfaces and to allow hair to protrude through its openings. Consequently, when the blades 14 are spinning or oscillating, hair that is protruding the fixed screen 12 is sheared by the moving foil blades 14.

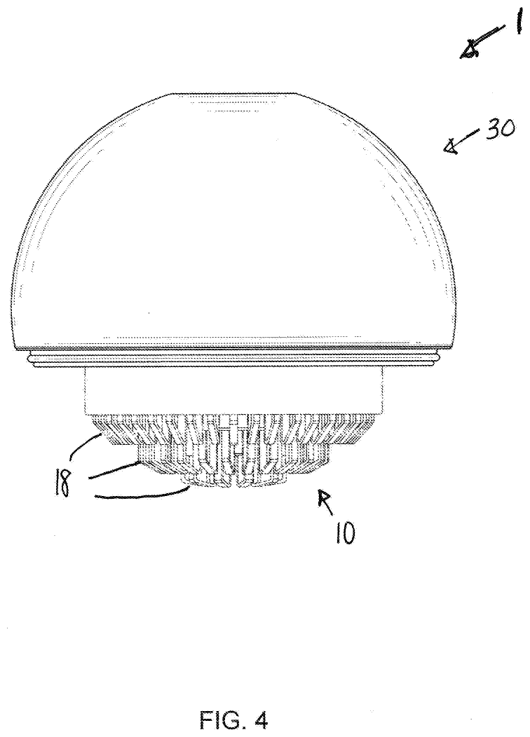

In a second preferred embodiment illustrated in FIG. 4, the razor 1 is a rotary blade-type electric razor in which the cutting head 10 features multiple rotary cutting blade assemblies 18 that are similarly arranged in concentric, vertical stepped relation to compositely form a spherical cap-shaped cutting surface. Each individual rotary blade assembly 18 is formed by a stationary outer cutter that has openings through which hair can extend and an inner cutter that rotates relative to its corresponding outer cutter. Hairs are severed by the rotating inner cutter when protruding through and being held in place by the relatively stationary outer cutter. The inner cutters are operatively connected to and rotationally powered by a motor via an appropriate drive assembly (not shown) of one or more drive shafts and gear arrangements.

As is the case with its foil-type blade counterpart, in this concentric rotary blade-type embodiment of the razor 1, it is contemplated that the gripping portion 30 of the razor 1 may have semispherical or entirely different profiles within the scope of the invention.

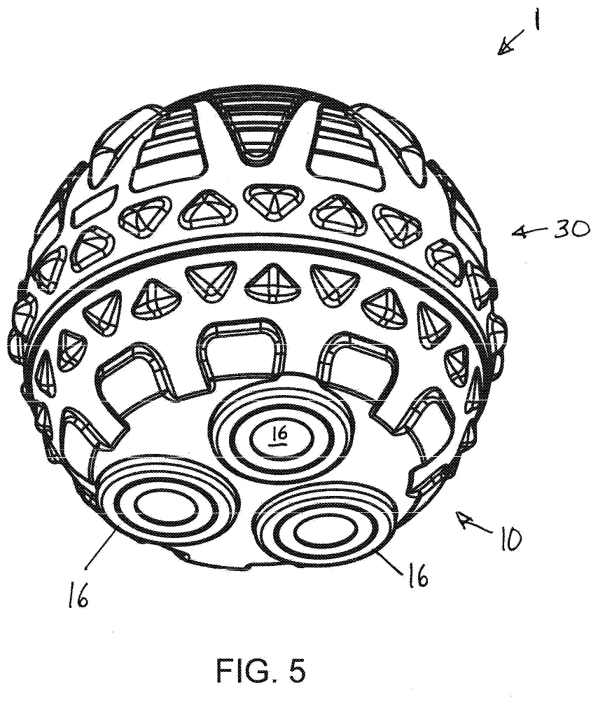

Finally, in another embodiment shown in FIGS. 5 and 6, the present device is a rotary blade-type razor, but where the cutting head 10 features rotary blade assemblies 16 that are non-concentric and are, instead, each positioned in spaced apart fashion about a spherical cap-shaped surface to, themselves, effectively form a compositely spherical cap-shaped cutting profile. Each rotary blade assembly 16 is configured as described above (i.e., with rotating inner and stationary outer cutters). As shown in FIG. 6, the electric motor 40 is connected to a main drive shaft 42 which it spins. Along this main shaft 42 is a main drive gear 44 that is in toothed engagement with a blade gear 46 that corresponds with each rotary blade assembly 16. Each blade gear 46 is fixed along a blade shaft 48 that spins the inner cutters of its rotary blade assembly 16. Through this mechanical cooperation, when the motor 40 is turned on, each blade 16 operates to cut hair.

It should be noted that although not specifically shown in the accompanying drawings, the present razor may include a pocket(s) of space—typically, beneath its blades—in which cut hair may collect and be held until affirmatively removed by the user.

Aspects of various embodiments of the present invention that are not recited above or claimed below may be noted from observing the illustrations included herein.

What is claimed is:

1. An electric razor for shaving contoured body surfaces and comprising:
a cutting head configured to shave hairs from arcuate surfaces of a user's body when slid therealong, wherein the cutting head comprises a plurality of cutters that, together, form a composite spherical cap-shaped cutting surface;
a gripping portion configured to be held during shaving; and
a motor that is operatively connected to the cutters to actuate their cutting movement.

2. The electric razor of claim 1, wherein said electric razor is substantially spherical.

3. The electric razor of claim 1, further comprising a collecting space for retaining hair that is cut by said cutters.

4. The electric razor of claim 1, wherein said cutting head comprises a spherical cap-shaped face and a plurality of rotary blade assemblies arranged along that face to form a composite spherical cap-shaped cutting surface, wherein each rotary blade assembly comprises:
an outer cutter having openings through which hair can protrude; and
an inner cutter configured to rotate relative to the corresponding outer cutter and, thereby, cut hair which protrudes that outer cutter, wherein the inner cutter is operatively connected to and rotationally powered by the motor.

5. The electric razor of claim 1, wherein said cutting head comprises a plurality of rotary blade assemblies which are arranged in concentric and vertical stepped relation to form a composite spherical cap-shaped cutting surface, wherein each such rotary blade assembly comprises:
an outer cutter ring having openings through which hair can protrude; and
an inner cutter ring configured to rotate relative to the corresponding outer cutter ring and, thereby, cut hair which protrudes that outer cutter ring, wherein the inner cutter ring is operatively connected to and rotationally powered by the motor.

6. The electric razor of claim 1, wherein said cutting head comprises:
a spherical cap-shaped screen having a plurality of openings; and
a plurality of blades arranged closely beneath the screen to form a composite spherical cap-shaped cutting surface for cutting hairs that protrude the screen openings.

7. The electric razor of claim 6, wherein said blades rotationally oscillate.

8. The electric razor of claim 6, wherein said blades rotate.

9. An electric razor comprising:
a cutting head configured to shave hairs from arcuate surfaces of a user's body when slid therealong, wherein the cutting head comprises:
a plurality of rings of blades, wherein these blade rings are arranged in concentric and vertical stepped relation to define a composite spherical cap-shaped cutting profile; and
a spherical cap-shaped screen disposed closely adjacent over the blades, wherein the screen has openings though which hair can protrude and be cut by the rotating blades;
a gripping portion configured to be held during shaving; and
a motor that is operatively connected to and rotationally powers the blade rings.

10. The electric razor of claim 9, wherein said electric razor is substantially spherical.

11. The electric razor of claim 9, further comprising a collecting space for retaining hair that is cut by said blades.
